(19) United States
(12) Patent Application Publication
(10) Pub. No.: US 2025/0386221 A1
(43) Pub. Date: Dec. 18, 2025

(54) IDENTIFY INFRASTRUCTURE WITH ML EMBEDDINGS

(71) Applicant: QUALCOMM Incorporated, San Diego, CA (US)

(72) Inventors: Himanshu JOSHI, San Jose, CA (US); June NAMGOONG, San Diego, CA (US); Taesang YOO, San Diego, CA (US); Jay Kumar SUNDARARAJAN, San Diego, CA (US); Eren BALEVI, Brooklyn, NY (US)

(21) Appl. No.: 18/741,687

(22) Filed: Jun. 12, 2024

(51) Int. Cl. H04W 24/10; H04L 1/00; H04L 1/1812; H04W 72/1273

(52) U.S. Cl. CPC H04W 24/10; H04L 1/0003; H04L 1/1812; H04W 72/1273

(57) ABSTRACT

Apparatus, methods, and computer program products for wireless communication are provided. An example method may include collecting a set of observation data associated with at least one network node. The example method may further include feeding the set of observation data to an embedding engine. The example method may further include receiving, from the embedding engine, a set of embeddings, the set of embeddings being a set of representations of one or more characteristics of a set of network nodes including the at least one network node. The example method may further include communicating with a second network node based on the set of embeddings.

### TECHNICAL FIELD

The present disclosure relates generally to communication systems, and more particularly, to wireless communication systems with machine learning (ML).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology and for additional wireless communication technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to collect a set of observation data associated with at least one network node. Based at least in part on information stored in the at least one memory, the at least one processor, individually or in any combination, is configured to feed the set of observation data to an embedding engine. Based at least in part on information stored in the at least one memory, the at least one processor, individually or in any combination, is configured to receive, from the embedding engine, a set of embeddings, the set of embeddings being a set of representations of one or more characteristics of a set of network nodes including the at least one network node. Based at least in part on information stored in the at least one memory, the at least one processor, individually or in any combination, is configured to communicate with a second network node based on the set of embeddings.

In another aspect of the disclosure, a method, a computer-readable medium, and an apparatus at a UE are provided. The apparatus may include at least one memory and at least one processor coupled to the at least one memory. Based at least in part on information stored in the at least one memory, the at least one processor, individually or in any combination, is configured to transmit, to an embedding engine upon a cell change, a set of link level protocol interaction data between the UE and a network node. Based at least in part on information stored in the at least one memory, the at least one processor, individually or in any combination, is configured to receive, from the embedding engine, an embedding associated with the network node, the embedding being a representation of one or more characteristics of the network node. Based at least in part on information stored in the at least one memory, the at least one processor, individually or in any combination, is configured to communicate with the network node based on the embedding.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is an illustrative block diagram of an example machine learning (ML) model represented by an artificial neural network (ANN), in accordance with various aspects of the present disclosure.

FIG. 5 is an illustrative block diagram of an example ML architecture 500 that may be used for wireless communications in any of the various implementations, processes, environments, networks, or use cases, in accordance with various aspects of the present disclosure.

FIG. 6 is an illustrative block diagram of an example ML architecture of first wireless device in communication with second wireless device, in accordance with various aspects of the present disclosure.

FIG. 7 is a diagram illustrating an example link level foundational model for generating embedding.

FIG. 8A is a diagram illustrating example communications between a network node and a UE, in accordance with various aspects of the present disclosure.

FIG. 8B is a diagram illustrating example communications between a network node and a UE, in accordance with various aspects of the present disclosure.

FIG. 9 is a flowchart of a method of wireless communication, in accordance with various aspects of the present disclosure.

FIG. 10 is a flowchart of a method of wireless communication, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a diagram illustrating an example of a hardware implementation for an example apparatus and/or network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Interoperability testing may be performed for UEs for wireless communication with different infrastructure vendors to ensure robustness and reliability. For example, an infrastructure vendor may correspond to a vendor, or manufacturer, of a base station or one or more components of a base station (e.g., a CU, DU, and/or RU). The UE may support some additional capabilities (e.g., tested capabilities) with one or more of the tested vendors that might not be supported for an untested vendor. During operation, a UE is aware of an operator, e.g., via a mobile country code (MCC) and/or mobile network code (MNC) signaling, but the UE is not aware whether an infrastructure vendor has been tested for the UE. Without knowing whether the infrastructure vendor is a tested vendor, the UE may not advertise (with accuracy) the additional capabilities. Aspects presented herein enable a UE to indirectly identifier (or infer) an infrastructure vendor associated with a network and to more accurately advertise additional capabilities that have been tested for the identified infrastructure vendor. Different network deployments use different scheduling algorithms and radio access network (RAN) radio configurations, and therefore, have different link level behaviors. The UE may identify an infrastructure vendor based on link level protocol interactions between a UE and a base station (e.g., gNB or network node). The UE may observe the link level interactions between the UE and the base station to build a representation of the base station scheduler and/or to identify the infrastructure vendor. In some aspects, the UE may use an artificial intelligence (AI) and/or machine learning (ML) model to make such inferences based on the link level protocol interactions between the UE and the base station. In some aspects, the AI/ML model may be based on a foundational model, e.g., a deep learning model trained on a large amount of data and adaptable to different scenarios or contexts having smaller amounts of data. The foundational model may include a backbone portion, e.g., expressed with various weight parameters, and an embedding portion, e.g., represented via a vector or tensor that represents a particular interaction. For example, the embedding may be considered as including a fingerprint for particular interactions, such as including infrastructure vendor specific information that is learned by an AI/ML model.

Aspects provided herein may involve using link level protocol interaction data between user equipments (UEs) and a network node as an input to a machine learning (ML) model to create a representation of the network node, and configuring a UE with such representation of the network node so that the UE may be able to more efficiently communicate with the network node by adapting its own behavior based on the representation of the network node. As one particular example, the UE may be performing grant prediction (e.g., predicting modulation and coding scheme (MCS) associated with a grant) based on the representation of the network node. Based on the grant prediction, the UE may adapt its RF transceiver.

Particular aspects of the subject matter described in this disclosure can be implemented to realize one or more of the following potential advantages. In some examples, by inferring the infrastructure vendor from the link level interactions, the UE may be able to determine whether the particular infrastructure vendor has been tested for the UE. If the vendor is a tested partner for the UE, the UE may advertise the tested capabilities (e.g., additional capabilities). If the vendor is not a tested partner, the UE may skip advertising the additional capabilities. This enables the UE to more accurately identify its capabilities to a network node based on the infrastructure vendor providing the network node. Alternatively, or additionally, the UE may build a model for a network scheduler based on the link level interactions, and may predict grants for wireless communication based on the model for the network scheduler. The prediction of such grants may enable the UE to prepare and more efficiently exchange wireless communication via a network node.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

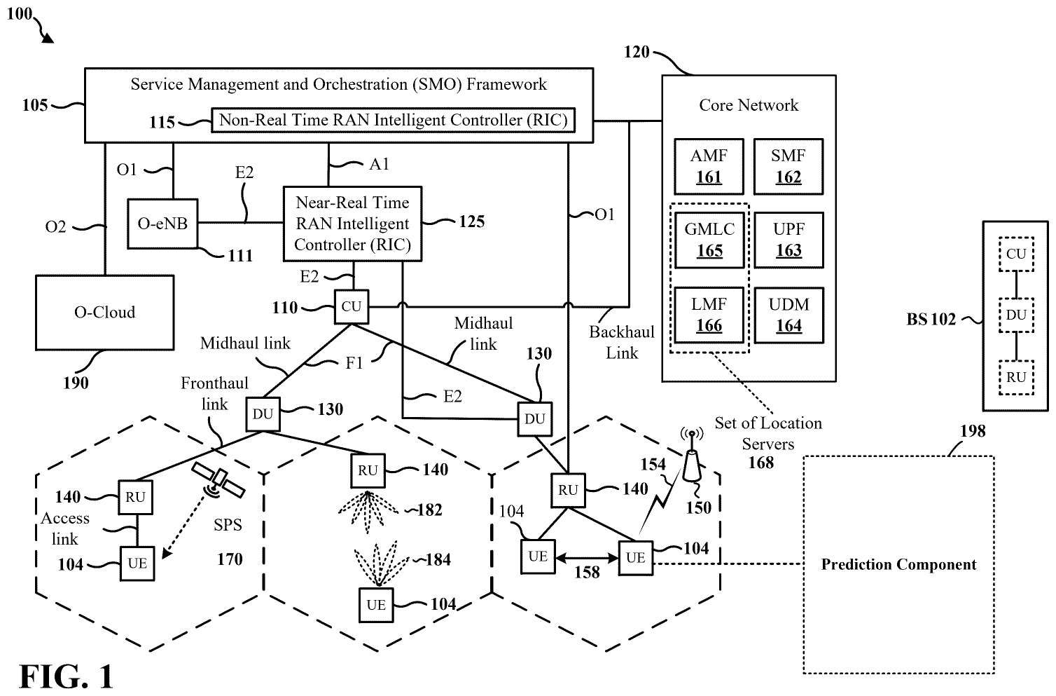

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUS 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a prediction component 198. In some aspects, the prediction component 198 may be configured to collect a set of observation data associated with at least one network node. In some aspects, the prediction component 198 may be configured to feed the set of observation data to an embedding engine. In some aspects, the prediction component 198 may be configured to receive, from the embedding engine, a set of embeddings, the set of embeddings being a set of representations of one or more characteristics of a set of network nodes including the at least one network node. In some aspects, the prediction component 198 may be configured to communicate with a second network node based on the set of embeddings.

In some aspects, the prediction component 198 may be configured to transmit, to an embedding engine upon a cell change, a set of link level protocol interaction data between the UE and a network node. In some aspects, the prediction component 198 may be configured to receive, from the embedding engine, an embedding associated with the network node, the embedding being a representation of one or more characteristics of the network node. In some aspects, the prediction component 198 may be configured to communicate with the network node based on the embedding.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

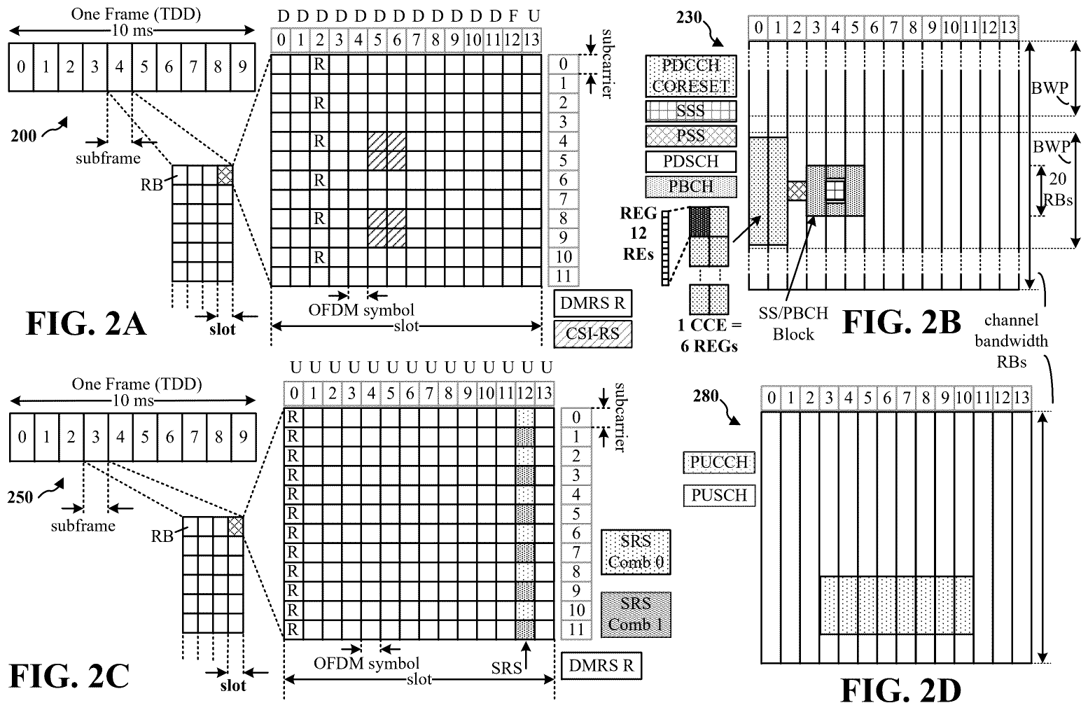

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

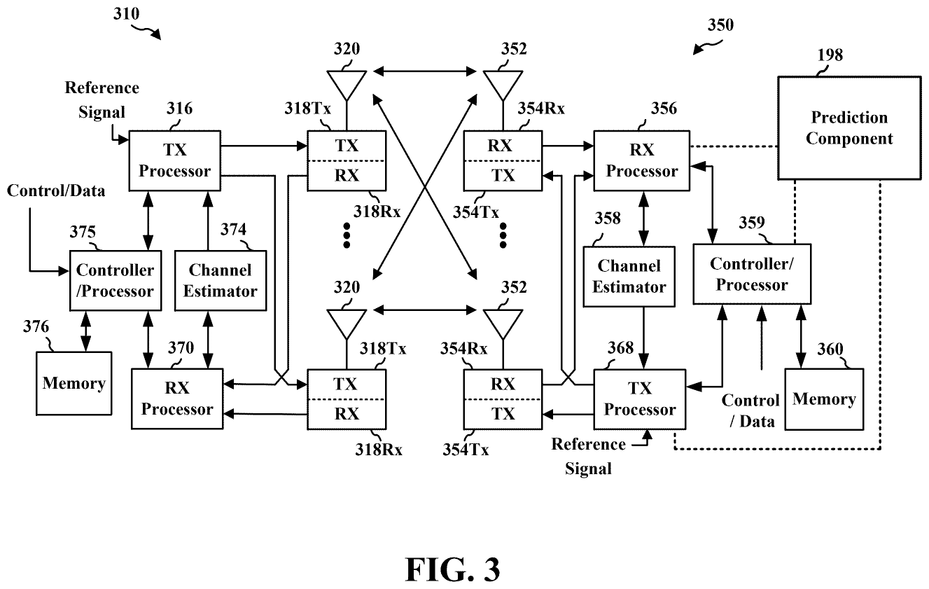

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with prediction component 198 of FIG. 1.

Certain aspects and techniques as described herein may be implemented, at least in part, using an artificial intelligence (AI) program, such as a program that includes a machine learning (ML) or artificial neural network (ANN) model. An example ML model may include mathematical representations or define computing capabilities for making inferences from input data based on patterns or relationships identified in the input data.

As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model.

In some aspects, an ML model may be configured to provide computing capabilities for wireless communications. Such an ML model may be configured as weights and biases to generate embeddings of a network node. In some aspects, the ML model may be based on a deep learning model that is trained on a large amount of data and can be adapted to specific scenarios and/or contexts with less, or limited, data. In some aspects, the model may be based on a backbone portion, where a larger part of the model is expressed via weight parameters, and an embedding portion that is a smaller part of the model that is represented via a vector or tensor containing a representation or ‘fingerprint’ of certain interactions, certain entities, or certain interactions with specific entities in the system. In some aspects, the weights may be vectors or tensors. As an example, an embedding portion may be based on infrastructure vendor specific information (or properties of a base station) that is learned by an AI/ML model.

As used herein, the term “embedding” may refer to a representation of one or more characteristics (which may also be referred to as “properties”) of a network node. In some aspects, the representation may be associated with a scheduler of the network node. In some aspects, an embedding may be categorized based on a manufacturer, or vendor, associated with the network node because different manufacturers or vendors may implement network differently, which may result in different characteristics. In some aspects, the infrastructure vendor may be referred to as an original equipment manufacturer (OEM). The network node may be a base station or one or more components of a base station. In some aspects, a wireless network operator may use infrastructure, or equipment, from various different infrastructure vendors or manufacturers. The embedding may be associated with a particular infrastructure vendor, for example. As used herein, the term “observation data” may refer to input data provided by a UE to an ML model configured to generate an embedding, or identify a previously generated embedding. The observation data may include link level protocol interaction data between the UE and a network node that the UE uses to identify an infrastructure vendor, or manufacturer, of the network node. The link level protocol interaction data may include data (e.g., data related to signaling of) associated with at least one of: a physical (PHY) layer signaling, a medium access control (MAC) level signaling, a hybrid automatic repeat request (HARQ) result, a channel state feedback (CSF) report, a channel quality indicator (CQI), a rank indicator, a physical downlink shared channel (PDSCH) grant rank, or a MCS. In some aspects, the link level protocol interaction data may also include associated radio link control session data unit (SDU) or protocol data unit (PDU) identifiers (IDs). For example, SDU or PDU IDs associated with the PHY layer signaling, the MAC level signaling, the HARQ result, the CSF report, the CQI, the rank indicator, or the PDSCH grant rank, may be included. In some aspects, the observation data may further include PHY level data such as different metrics (reference signal received power, received signal strength indicator, signal to interference and noise ratio, or the like), RLC level data such as SDU segmentation information, or other data. An entity configured with the ML model configured to generate an embedding may be referred to as an “embedding engine.” An embedding engine may be located at a server separate from the UE, or at the UE itself.

Aspects provided herein may involve using link level protocol interaction data between UE(s) and a network node as an input to a ML model to create a representation of the network node, and configuring a UE with such representation of the network node so that the UE may be able to more efficiently communicate with the network node, by advertising or employing one or more capabilities (e.g., additional capability or enhanced capabilities) supported by the UE and for which interoperability testing has been conducted for the identified vendor/manufacturer of the network node. In some aspects, the additional capability may include performing grant prediction (e.g., predicting modulation and coding scheme (MCS) associated with a grant). Based on the grant prediction, the UE may adapt its RF transceiver. To facilitate aspects provided herein, some signaling between the UE and a network node may be present. Other examples of capabilities may correspond to one or more capabilities supported by the UE for one or more band combinations, one or more capabilities associated with MIMO configurations (e.g., 6RX), or one or more capabilities associated with a supplemental uplink (SUL), among other examples. For example, a first signaling between the UE to a network node may provide radio resource control (RRC) configuration with a foundational model identifier (ID) associated with a backbone and one or more embeddings to the UE. A second signaling may provide an RRC capability update associated with the UE to the network node, e.g., an update that indicates, or is associated with, one or more additional UE capabilities supported by the UE and which has been tested for the identified infrastructure vendor/manufacturer of the network node. In some aspects, in a first signaling exchange, a set (e.g., a minimal set) of capabilities may be transmitted based on RRC signaling. Subsequently, based on some aspects provided herein, the UE may identify the network node based on a foundation model (e.g., associated with the embeddings). After the UE identifies the network node based on the foundation model, the UE may advertise additional capabilities based on the UE's knowledge of the network node. The UE may also perform capability update based on the identification of the network node. The UE may also adjust its power management based on the identification of the network node. In some aspects, the UE may also adjust its power/radio/memory/sleep management based on the identification of the network node.

In some aspects, a backbone may be trained (or pretrained) on dataset constructed by sampling a larger amount of data, and each embedding of a larger set of the embeddings may be finetuned (e.g., trained) on a smaller subset of data for a respective particular configuration. An accuracy of the ML model may be evaluated based on grant prediction performance using the embeddings. As one, non-limiting example, a pretrained model may be trained with a large amount of data from a variety of sources, such as data from a large number of infrastructures, a large number a geographical regions, and/or a large number of markets. In one example, a model such as a model with a portion of a Vision Transformer (ViT) architecture may be used for the backbone portion of the model. For finetuning, a smaller amount of new data may be used with the pretrained model to train a new embedding, or fingerprint associated with a particular infrastructure vendor, which may be compared with a larger set of previously generated embeddings associated with the particular infrastructure vendor to identify an infrastructure of the network node.

Examples of observation data, which enables the UE to identify a particular infrastructure vendor/manufacturer, may include a set of link level protocol interaction data between the UE and at least one network node so that the embedding engine may generate embedding of that at least one network node (e.g., for the infrastructure vendor/manufacturer of the network node), or may use to identify a previously generated embedding for the at least one network node (e.g., the vendor/manufacturer of the network node). An embedding engine may generate an embedding for a network node (e.g., an infrastructure or equipment vendor/manufacturer of the network node) based on observation data regarding the network node provided by different UEs. Based on weights and biases, the embedding engine may generate embeddings associated with network node(s). The embedding may form a fingerprint that can be used to identify other network nodes from the same vendor/manufacturer. The UE may have information, e.g., stored information, that informs the UE whether interoperability for one or more additional capabilities have been tested and are supported with various infrastructure vendors/manufacturers. Once the UE identifies that a network node, such as a base station, is manufactured by a particular vendor, the UE may use the stored information to determine which additional capabilities are tested and supported with the particular vendor. By identifying a particular infrastructure vendor, the UE can tailor its behavior, such as its capability reporting, based on the identified vendor.

ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of defined output values, and regression refers to determining continuous values which are not bounded by predefined output values. For example, a classification ML model configured according to aspects of this disclosure may produce an output which includes embeddings that includes representations of various characteristics associated with different network nodes (e.g., categorized based on respective manufacturer of the network nodes or by different SW versions of the same manufacturer).

Examples of models that may be used by an embedding engine may be a deep learning model, convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), or the like. To facilitate the discussion, an ML model configured using an ANN is used, but it should be understood, that other types of ML models may be used instead of an ANN. Hence, unless expressly recited, subject matter regarding an ML model is not intended to be limited to an ANN solution. Further, it should be understood that, unless otherwise specifically stated, terms such “AI/ML model,” “ML model,” “trained ML model,” “ANN,” “model,” “algorithm,” or the like are intended to be interchangeable.

In one particular aspects the embedding engine may be configured to use a deep learning model that can be considered to be made of a “backbone” and an “embedding”. The backbone may be expressed via its weight parameters. The embeddings may be represented via vectors or tensors containing representations (or otherwise referred to as “fingerprints”) of the one or more characteristics of the network node. The backbone may be considered as “fixed” or “invariant” part of the model or the embedding engine and may include weight parameters. The backbone part of the model may be trained on large amounts of data so that it is generic and may be reused in various different situations. The “fingerprint” or “embedding” part of the model may include of weight vector(s) or tensor(s) that may be finetuned to capture certain aspects of the network node, which may be trained based on a smaller amount of data. The one or more characteristics may include, by way of example, a prediction regarding a MCS under different situations associated with the network node, a manufacturer associated with the network node, a prediction regarding a rank under different situations associated with the network node, band, numerology, frequency, or other information regarding a grant provided by the network node under different situations, or the like.

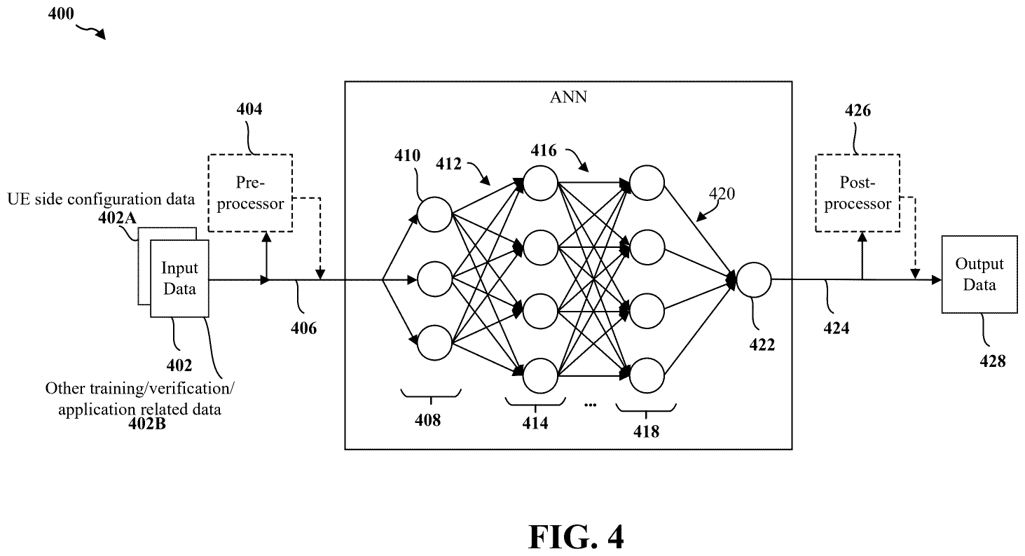

FIG. 4 is an illustrative block diagram of an example machine learning (ML) model represented by an artificial neural network (ANN) 400. ANN 400 may receive input data 406 which may include one or more bits of data 402, pre-processed data output from pre-processor 404, or some combination thereof. The data 402 may include UE side configuration data 402A and other training, verification, and application related data 402B.

ANN 400 includes at least one first layer 408 of artificial neurons 410 to process input data 406 and provide resulting first layer data via connections or “edges” such as edges 412 to at least a portion of at least one second layer 414. Second layer 414 processes data received via edges 412 and provides second layer output data via edges 416 to at least a portion of at least one third layer 418. Third layer 418 processes data received via edges 416 and provides third layer output data via edges 420 to at least a portion of a final layer 422 including one or more neurons to provide output data 424. All or part of output data 424 may be further processed in some manner by (optional) post-processor 426. Thus, in certain examples, ANN 400 may provide output data 428 that is based on output data 424, post-processed data output from post-processor 426, or some combination thereof.

Post-processor 426 may be included within ANN 400 in some other implementations. Post-processor 426 may, for example, process all or a portion of output data 424 which may result in output data 428 being different, at least in part, to output data 424, as result of data being changed, replaced, deleted, etc. In some implementations, post-processor 426 may be configured to add additional data to output data 424. In this example, second layer 414 and third layer 418 represent intermediate or hidden layers that may be arranged in a hierarchical or other like structure. Although not explicitly shown, there may be one or more further intermediate layers between the second layer 414 and the third layer 418. In some implementations, the post-processor 426 may be a ML model, such as an ANN. In some aspects, the post-processor 426 may be configured to generate one or more embeddings in a format that may be transmitted to or configured for a UE. In some aspects, at an UE, the post-processor 426 may generate grant prediction and may adapt a RF transceiver at the UE based on the grant prediction. In some aspects, the embeddings may be considered to be part of the post-processor 426 or part of the ANN (e.g., as neuron weights in the edges 412).

The structure and training of artificial neurons 410 in the various layers may be tailored to specific requirements of an application. Within a given layer such as first layer 408, second layer 414, or third layer 418 of ANN 400, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of ANN 400. The weights and biases of ANN 400 may be adjusted during a training process or during operation of ANN 400 (e.g., changing the embedding based on mobility changes the UE undergoes). The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 406. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 400, may be conducted using training data. Training data may include one or more datasets which ANN 400 may use to identify patterns or relationships. Training data may represent various types of information, including written, visual, audio, environmental context, operational properties, etc. During training, the parameters (such as the weights and biases) of artificial neurons 410 may be changed, such as to minimize or otherwise reduce a loss function or a cost function. A training process may be repeated multiple times to fine-tune ANN 400 with each iteration. In some aspects, the training data may include observation data collected by the UE and do not include observation data collected by other UEs. In some aspects, the training data may include observation data collected by various UEs. The observation data may include link level protocol interaction data between the UE and a network node. The link level protocol interaction data may include data (e.g., data related to signaling of) associated with at least one of: a PHY layer signaling, a MAC level signaling, a HARQ result, a CSF report, a CQI, a rank indicator, a PDSCH grant rank, or a MCS.

Various ANN model structures are available for consideration. For example, in a feedforward ANN structure, each artificial neuron 410 in layer 414 receives information from the previous layer (such as, one or more artificial neurons 410 in layer 408) and produces information for the next layer (such as, one or more artificial neurons 410 in layer 418). In a convolutional ANN structure, some layers may be organized into filters that extract features from data, such as the training data or the input data. In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer ANN structure may include a series of feedforward ANN layers whose configurations may change in response to identifying non-linear relationships between the input and output sequences, which may also be referred to as a process of “learning” by the ANN layers. The output of a transformer ANN structure may be obtained by applying a linear transformation to the output of a final attention layer. A transformer ANN structure may be of particular use for tasks that involve sequence modeling, or other like processing.

Another example type of ANN structure is a model with one or more invertible layers. Models of this type may be inverted or “unwrapped” to reveal the input data that was used to generate the output of a layer. Other example types of ANN model structures include fully connected neural networks (FCNNs) and long short-term memory (LSTM) networks.

ANN 400 or other ML models may be implemented in various types of processing circuits along with memory and applicable instructions therein. For example, general-purpose hardware circuits, such as, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed. In some implementations, the ML model may be implemented by a NPU or a TPU embedded in a system on chip (SoC) along with other components, such as one or more CPUs, GPUs, etc. An SoC includes several components manufactured on a shared semiconductor substrate. The NPU or TPU may be controlled by the one or more CPUs by configuring the ML model implemented by the NPU or TPU with weights and biases, providing certain training data to the ML model to configure the ML model, or providing input data to the ML model to obtain related inferences. The one or more CPUs may also receive the inferences and be configured to perform certain actions based on the inferences produced by the ML model. The actions performed by the one or more CPUs may include sending commands to other components of the SoC or components external to the SoC to perform certain actions. For example, the CPU may send commands to a RF transceiver based on the outputs or inferences obtained from an ML model to cause the RF transceiver to operate on a wireless network in accordance with the ML model. For example, when the UE is configured with a local embedding engine, the UE may be configured to operate based on one or more embeddings configured for the UE. As another example, the UE may be configured with an prediction component 198 configured to use the one or more configured embeddings for wireless communication with a network node. In some aspects, the UE may also be configured with a backbone of a model so that the UE may be able to perform grant prediction while communicating with a network node.

In example aspects, an ML model may be trained prior to, or at some point following, operation of the ML model, such as ANN 400, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data be the observation data collected by the UE. The observation data may include link level protocol interaction data between the UE and a network node. The link level protocol interaction data may include data (e.g., data related to signaling of) associated with at least one of: a PHY layer signaling, a MAC level signaling, a HARQ result, a CSF report, a CQI, a rank indicator, a PDSCH grant rank, or a MCS. In some aspects, the observation data may further include PHY level data such as different metrics (reference signal received power, received signal strength indicator, signal to interference and noise ratio, or the like), RLC level data such as SDU segmentation information, or other data.

Offline training may refer to creating and using a static training dataset, such as, in a batched manner, whereas online training may refer to a real-time collection and use of training data. For example, an ML model at a network device (such as, a UE) may be trained or fine-tuned using online or offline training. For offline training, data collection and training can occur in an offline manner at the UE side. For online training, the training of a UE-side ML model may be performed locally at the UE or by a server device in a real-time or near-real-time manner based on data provided to the server device from the UE. In certain instances, all or part of the training data may be shared within in a wireless communication system, or even shared (or obtained from) outside of the wireless communication system. In some aspects, the embedding engine may be located at the UE or a separate device. In some aspects, the prediction component 198 is located at the UE.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, re-training it on the data, or using different optimization techniques, or the like. In some aspects, as an example, the observation data may be used as validation dataset by comparing an identified infrastructure to the accuracy of communication exchanged with the network node, e.g., which may help the UE to determine whether the identification of the particular vendor from the link level interaction was accurate. In some aspects, as an example, the observation data may be used as validation dataset by comparing grant prediction performance based on different embeddings to verify the accuracy of the embeddings. In some aspects, observation data at an earlier time may be used as input data for training a ML model to generate an embedding. Observation data at a later time from the same UE associated with a same network node may be used as validation dataset for verifying whether infrastructure vendor identification or grant predictions based on the generated embedding is accurate compared to an actual grant in the validation data set. In some aspects, the validation data set may also include known characteristics of one or more network nodes and the known characteristics of one or more network nodes may be compared with the generated embeddings. In some aspects, a transfer learning technique may be used which involves using a pre-trained model as a starting point for training a new model, which may be useful when training data is small or when there are multiple tasks that are related to each other.

As part of a training process, parameters affecting the functioning of the artificial neurons and layers may be adjusted. For example, backpropagation techniques may be used to train an ANN by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases as needed to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an on-going training process early, such as when a performance of the model using a validation dataset starts to degrade.

Another example technique includes data augmentation to generate additional training data by applying transformations to all or part of the training information. A transfer learning technique may be used which involves using a pre-trained model as a starting point for training a new model, which may be useful when training data is small or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ANN is a “pruning” technique. A pruning technique, which may be performed during a training process or after a model has been trained, involves the removal of unnecessary or less necessary, or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Knowledge distillation techniques may be used to reduce the complexity of the model(s) to optimize available resources. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored. Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain example implementations, pruning techniques also may be applied to training data, for example, to remove outliers. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model. In some aspects, label balancing may be performed to create a balanced training set, which may include zeroing (normalization), or standardization (dividing by the standard deviation), or the like.

One or more of the example training techniques presented above may be employed as part of a training process. Some example training processes that may be used to train an ANN include supervised learning, unsupervised learning, semi-supervised learning, and reinforcement learning technique. With supervised learning, a model is trained on a labeled training dataset, wherein the input data is accompanied by a correct or otherwise acceptable output. With unsupervised learning, a model is trained on an unlabeled training dataset, such that the model will need to learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize a behavior of a model deployed in a dynamically changing environment.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities.

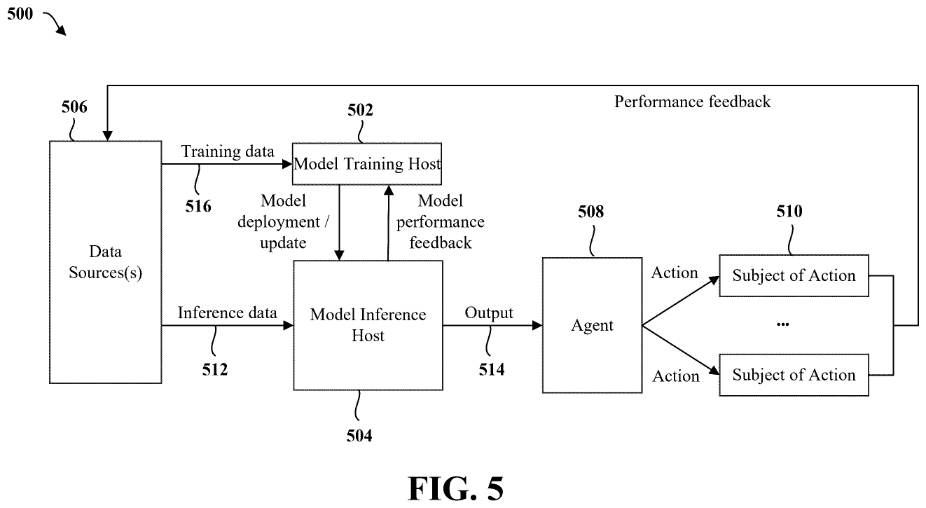

FIG. 5 is an illustrative block diagram of an example ML architecture 500 that may be used for wireless communications in any of the various implementations, processes, environments, networks, or use cases listed above. As illustrated, architecture 500 includes multiple logical entities, such as model training host 502, model inference host 504, data source(s) 506, and agent 508. Model inference host 504 is configured to run an ML model based on inference data 512 provided by data source(s) 506. Model inference host 504 may produce output 514, which may include a prediction or inference, such as a discrete or continuous value based on inference data 512, which may then be provided as input to the agent 508.

Agent 508 may represent an element or an entity of a wireless communication system including, for example, a radio access network (RAN), a wireless local area network, a device-to-device (D2D) communications system, etc. As an example, agent 508 may be a user equipment (such as the UE 104) that is configured with the prediction component 198 and may use the embeddings to adapt its behavior when communicating with a network node. Additionally, agent 508 also may be a type of agent that depends on the type of tasks performed by model inference host 504, the type of inference data 512 provided to model inference host 504, or the type of output 514 produced by model inference host 504. The output 514 may be one or more embeddings generated by an embedding engine. In some aspects, the output 514 may be one or more grant predictions generated based on the one or more embeddings.

Agent 508 may perform one or more actions associated with receiving output 514 from model inference host 504. For example, the UE 104 may be able to more efficiently communicate with the network node by adapting its own behavior based on the representation of the network node, e.g., based on the identification of an infrastructure vendor/manufacturer for the network node for which interoperability testing has been performed. As one particular example, the UE may be performing grant prediction (e.g., predicting MCS associated with a grant) based on the representation of the network node. Based on the grant prediction, the UE may adapt its RF transceiver. In some aspects, the UE may use different power management algorithm (e.g., perform power management differently) based on the representation of the network node. As another example, a UE may select one or more additional capabilities to advertise to the network node based on identifying the infrastructure vendor of the network node as one for which interoperability testing has been performed for the UE for the one or more additional capabilities. As another example, the UE may also adjust its power/radio/memory/sleep management based on the identification of the network node.

Data can be collected from data sources 506, and may be used as training data 516 for training an ML model, or as inference data 512 for feeding an ML model inference operation. Data sources 506 may collect data from various subject of action 510 entities (such as, the UE), and provide the collected data to a model training host 502 for ML model training. In some aspects, the data sources 506 may be the UE itself and the training data 516 may be observation data provided by the UE itself. In some aspects, the data sources 506 do not include data not visible to the UE itself. In some aspects, the data sources 506 do not include network side data not visible to the UE itself. In some examples, if output 514 provided to agent 508 is inaccurate (or the accuracy is below an accuracy threshold), model training host 502 may provide feedback to model inference host 504 to modify or retrain the ML model used by model inference host 504, such as via an ML model deployment update.

Model training host 502 may be deployed at the same or a different entity than that in which model inference host 504 is deployed. For example, in order to offload model training processing, which can impact the performance of model inference host 504, model training host 502 may be deployed at a model server.

In some aspects, an ML model is deployed at or on a network entity or a server separate from the network entity. More specifically, a model interference host, such as model inference host 504 in FIG. 5, may be deployed at or on the network entity or a server separate from the network entity.

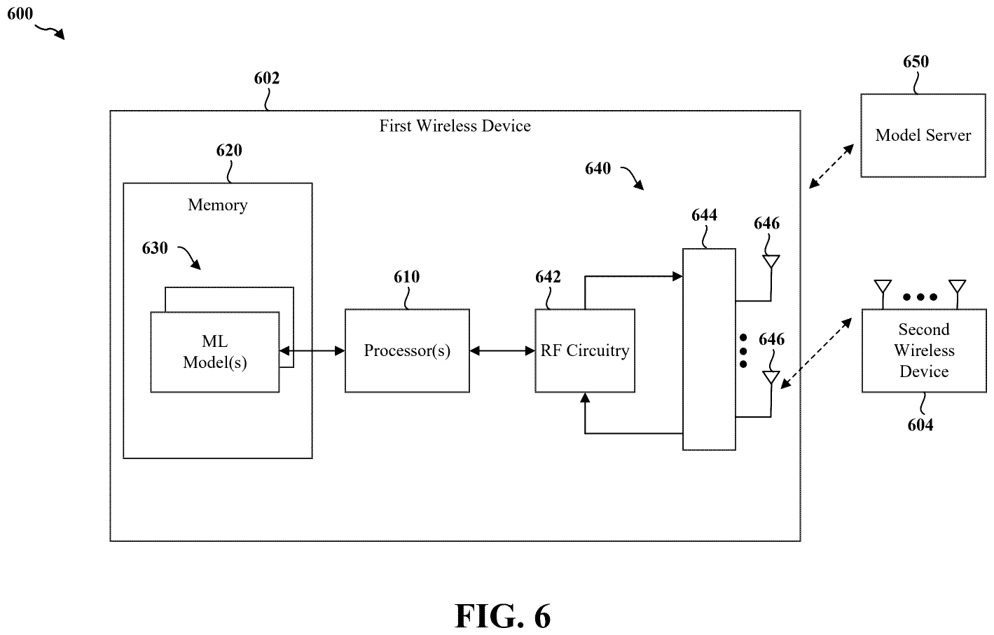

FIG. 6 is an illustrative block diagram of an example ML architecture 600 of first wireless device 602 in communication with second wireless device 604. First wireless device 602 may be a UE. Similarly, the second wireless device may also be a UE. Note that the example ML architecture of first wireless device 602 may be applied to second wireless device 604, and vice versa.

First wireless device 602 may be, or may include, a chip, system on chip (SoC), chipset, package or device that includes one or more processors, processing blocks or processing elements (collectively “processor 610”) and one or more memory blocks or elements (collectively “memory 620”). Processor 610 may be coupled to transceiver 640, which includes radio frequency (RF) circuitry 642 coupled to antennas 646 via interface 644, for transmitting or receiving signals.

One or more ML models 630 (collectively “ML model 630”) may be stored in memory 620 and accessible to processor(s) 610. Individual or groups of ML models 630 may be associated with respective model identifiers. In some aspects, different ML models 630, which may optionally be associated with different model identifiers, may have different characteristics. One or more ML models 630 may be selected based on respective features, characteristics, or applications, as well as characteristics or conditions of first wireless device 602 (such as, a power state, a mobility state, a battery reserve, a temperature, etc.). For example, ML models 630 may have different inference data and output pairings (such as, different types of inference data produce different types of output), different levels of accuracies associated with the predictions, different latencies associated with producing the predictions, different ML model sizes, different coefficients, different parameters, etc.

Processor 610 may deploy ML models 630 to produce respective output data based on input data. As an example, the output data may be grant predictions based on different embeddings and observation data, which are representations of one or more characteristics (which may also be referred to as “properties”) of different network nodes. A particular embedding may be associated with a particular scheduler of the particular network node with a particular software version and parameter set. In some aspects, an embedding may be categorized based on a manufacturer associated with the network node. The input data may be observation data which may include link level protocol interaction data between the UE and a network node. The link level protocol interaction data may include data (e.g., data related to signaling of) associated with at least one of: a PHY layer signaling, a MAC level signaling, a HARQ result, a CSF report, a CQI, a rank indicator, a PDSCH grant rank, or a MCS. As a particular example, the processor 610 may perform one or more grant predictions based on link level interaction data associated with the first wireless device 602 and the one or more configured embeddings.

In some aspects, model server 650 may perform various ML management tasks for first wireless device 602 and/or second wireless device 604. In some cases, the model server 650 may receive and store data from various data sources (such as data source 506) to collect and host training data, inference data, performance feedback, etc., associated with ML model 630. The model server 650 may forward some data received for local on device or other types of finetuning to the UEs. For example, the model server 650 may collect various observation data collected from different UEs. The model server may host various types and/or versions of ML models 630 for first wireless device 602 and/or second wireless device 604 to download. Model server 650 may monitor and evaluate the performance of ML model 630. Model server 650 may transmit signals or provide indications/instructions to activate or deactivate the use of a particular ML model at first wireless device 602 or second wireless device 604. Model server 650 may switch to a different ML model being used at first wireless device 602 or second wireless device 604, and model server 650 may provide such an instruction to the respective first wireless device 602 or second wireless device 604. Model server 650 may operate as a model training host (such as model training host 502) and update ML model 630 using training data.

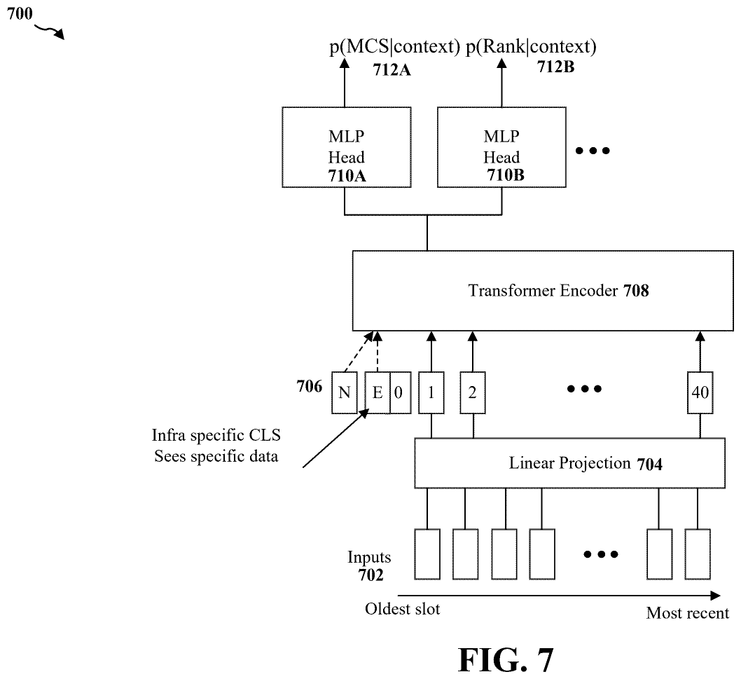

FIG. 7 is a diagram 700 illustrating an example link level foundational model that may be used for generating embedding, e.g., to identify an infrastructure vendor for a network node. In some aspects, to generate an embedding, an embedding engine may use a vision transformer. As illustrated in FIG. 7, a set of inputs 702 may be processed based on linear projection 704. The set of inputs 702 may be based on observation data that may include link level protocol interaction data between the UE and a network node. The link level protocol interaction data may include data (e.g., data related to signaling of) associated with at least one of: a PHY layer signaling, a MAC level signaling, a HARQ result, a CSF report, a CQI, a rank indicator, a PDSCH grant rank, or a MCS. In some aspects, the link level protocol interaction data may be slot-level (e.g., associated with a particular respective slot). In some aspects, the link level protocol interaction data may be correlated based on system frame number (SFN). In some aspects, the linear projection 704 may include WX plus B, where W is a vector of weights and X is a collection data, and B is a set of biases.

Output data 706 of the linear projection 704 may include slot positional data. For example, output data 706 may include separate data for slot 0, slot 1, . . . slot 40. In some aspects, the output data 706 may include a set of randomly initialized vectors E. The output data 706 may alternatively include a vector N, which may be a different set of randomly initialized vectors N. In some aspects, the randomly initialized vectors E and the randomly initialized vectors N may be categorized based on different manufacturer of a network node. In some aspects, specific classify (CLS) token may be used for classifying the observation data and the specific CLS token may be based on manufacturer(s) or model identifiers of the network node.

The transform encoder 708 may use the output data 706 from the linear projection 704 and generate data for multi-layer perceptron (MLP) head, such as a first MLP head 710A and a second MLP head 710B. The MLP head may be a feedforward artificial neural network. In some aspects, the first MLP head 710A may process data related to MCS in the observation data and may generate MCS context data 712A. In some aspects, the second MLP head 710B may process data related to rank in in the observation data and may generate rank context data 712B. Similarly, there may be different MLP head(s) for a PHY layer signaling, MAC level signaling, HARQ result, CSF report, CQI, or the like. In some aspects, an embedding may be used for collection of output of different MLP head(s) with regard to all of the PHY layer signaling, MAC level signaling, HARQ result, CSF report, CQI. For example, a first MLP head may be configured to process data related to MCS and generate MCS context data based on data relevant to the MCS in the set of inputs 702, a second MLP head may be configured to process data related to rank and generate rank context data based on data relevant to the rank in the set of inputs 702, a third MLP head may be configured to process data related to PHY layer signaling and generate PHY layer signaling context data based on data relevant to the PHY layer signaling in the set of inputs 702, a fourth MLP head may be configured to process data related to MAC level signaling and generate MAC level signaling context data based on data relevant to the MAC level signaling in the set of inputs 702, a fifth MLP head may be configured to process data related to HARQ result and generate HARQ result context data based on data relevant to the HARQ result in the set of inputs 702, a sixth MLP head may be configured to process data related to CSF report and generate CSF report context data based on data relevant to the CSF report in the set of inputs 702, a seventh MLP head may be configured to process data related to CQI and generate CQI context data based on data relevant to the CQI in the set of inputs 702, or the like. In some aspects, the set of inputs 702 may include data related to each MLP head. For example, to feed data for the first MLP head 710A, the set of inputs 702 may include MCS data.

In some aspects, configured with embeddings for the example link level foundational model illustrated in FIG. 7, a UE may be able to predict a next grant associated with a network node. In some aspects, a UE may be configured with a backbone of the link level foundational model illustrated in FIG. 7 and may perform grant prediction accordingly. In some aspects, the UE may also perform other predictions, such as predictions of PDSCH position, or the like.

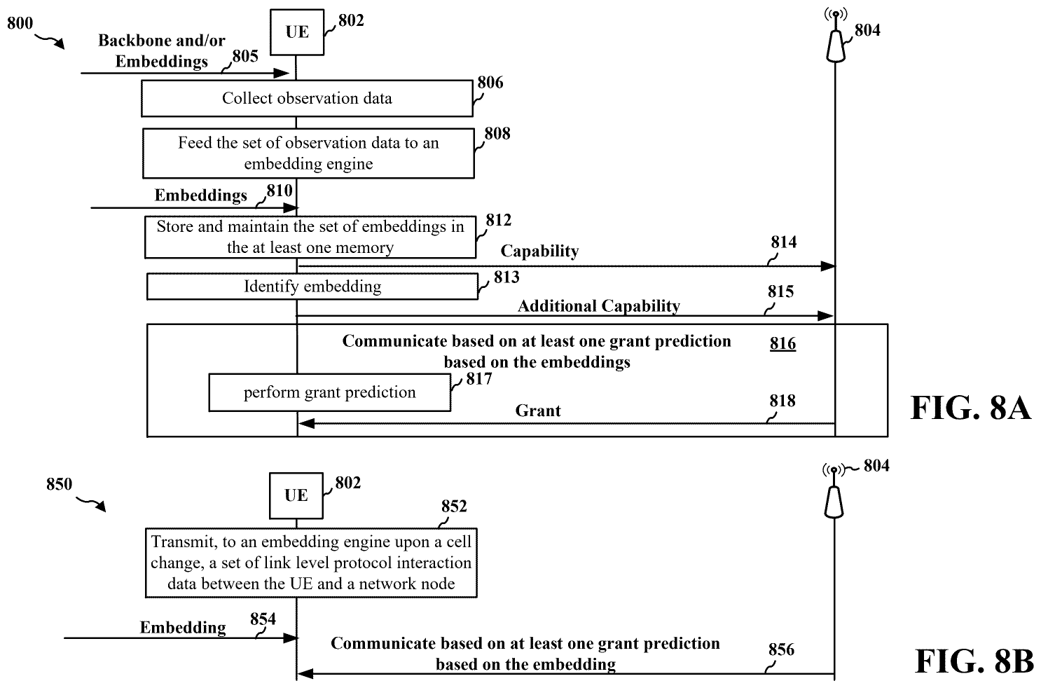

FIG. 8A is a diagram 800 illustrating example communications between a network node 804 and a UE 802, in accordance with various aspects of the present disclosure. Different network deployments may use different scheduling algorithms and RAN radio configurations, and therefore, have different link level behaviors. An infrastructure (e.g., a network node such as a base station or one or more components of a base station that are sourced from a particular infrastructure vendor/manufacturer) can be represented as an embedding that can be derived based on link level protocol interactions between a UE and the network node. As different base station vendors may implement various features differently, the different implementations affect the link level interaction, such as link level scheduling of UEs. By observing the link level UE to base station interaction, the UE can build a representation of the base station scheduler. In addition to being helpful to represent a base station's scheduler, the link level interaction can be used to identify the infrastructure vendor/manufacturer.

As illustrated in FIG. 8A, at 806, the UE 802 may collect a set of observation data associated with at least one network node. In some aspects, the set of observation data includes a set of link level protocol interaction data between the UE and the at least one network node, where the set of link level protocol interaction data includes data associated with at least one of: a PHY layer signaling, a MAC level signaling, a HARQ result, a CSF report, a CQI, a rank indicator, a PDSCH grant rank, or a MCS. At 808, the UE 802 may feed the set of observation data to an embedding engine, which may be resided locally at the UE 802 or a separate server.

In some aspects, the embedding engine may use observation data from various different UEs to generate one or more embeddings. In some aspects, the UE 802 may receive embeddings 805 or 810 from the embedding engine. Embeddings 805 and 810 illustrate that the UE may receive, and store, the embedding information at any time. In some aspects, the embeddings 805 or 810 may be provided based on a location of the UE 802. In some aspects, the embeddings 805 or 810 may be provided based on location and mobile country code (MCC) or mobile network code (MNC) (e.g., operator information) as advertised by the network node. For example, the embedding engine may identify embeddings to be provided to the UE 802 based on a location of the UE 802. In some aspect, the foundational model may be provided to the UE, e.g., at 805. For example, the foundational model may include a backbone option of the model and one or more known embeddings for different infrastructure vendors.

As described in connection with FIGS. 4-7, the embedding may be used as part of a model, in combination with a backbone portion of the model, to identify an infrastructure vendor/manufacturer of a network node (e.g., base station) for which the link level interaction is observed. The embedding may be developed in a collaboration between a UE vendor/manufacturer and the network infrastructure vendor/manufacturer, e.g., in connection with interoperability testing. The UE 802 may maintain a list of such embeddings for each of the known infrastructure vendors with which it supports particular capabilities, or for which interoperability testing has been performed. In some aspects, the UE may also maintain a list of features supported for each of the known infrastructure vendors, e.g., a list of additional features or capabilities that are not supported on untested infrastructures.

As illustrated at 812, the UE 802 may store and maintain the received embeddings 810. In some aspects, the embeddings 805 may be stored as a part of the embedding engine to which the observation data is fed at 808. In some aspects, after storing and the received embeddings 810, the UE 802 may transmit a capability indication 814 to inform a currently serving network node 804 of the UE 802 indicating that the UE 802 is configured with embeddings.

As illustrated at 813, the UE 802 may identify an embedding that corresponds to the observation data collected at 806. As an example, the UE can identify an infrastructure vendor for the network node 804 based on the identified, or selected, embedding. As an example, the UE may select a grant predictor embedding that is above a certain performance threshold. As illustrated at 815, the UE 802 may send a UE capability update message to the network node 804 to advertise one or more capabilities that are interoperability features that have been tested for the UE with the identified infrastructure vendor. The one or more capabilities may be capabilities that are not supported for other infrastructure vendors, for example. The UE may advertise the additional capability based on the identification of the particular infrastructure vendor for the network node 804.

At 816, the UE 802 may communicate with the network node 804 based on at least one grant prediction based on the embeddings. For example, at 817, the UE 802 may perform grant predictions based on the embedding identified at 813, and adapt a transceiver of the UE 802 based on the grant prediction(s). In some aspects, the UE 802 may perform grant prediction using multiple potential embeddings in parallel and choose (or identify) the best performing embedding (e.g., by comparing a predicted grant with an actually received grant 818) for subsequent communications.

FIG. 8B is a diagram 850 illustrating example communications between a network node 804 and a UE 802, in accordance with various aspects of the present disclosure. Upon a cell change, at 852, the UE 802 may transmit, to an embedding engine upon a cell change, a set of link level protocol interaction data between the UE and the network node 804. At 854, the UE 802 may receive, from the embedding engine, an embedding associated with the network node 804, the embedding being a representation of one or more characteristics of the network node. In some aspects, the embedding may be based on the set of link level protocol interaction data between the UE and the network node 804. At 856, the UE 802 may communicate with the network node 804 based on the embedding (e.g., by performing at least one grant prediction of a next grant from the network node based on the embedding and adapt its transceiver accordingly). After 856, the UE 802 may transmit, to the embedding engine, a set of additional link level protocol interaction data at least one grant prediction and receive an updated embedding from the embedding engine based on the set of additional link level protocol interaction data.

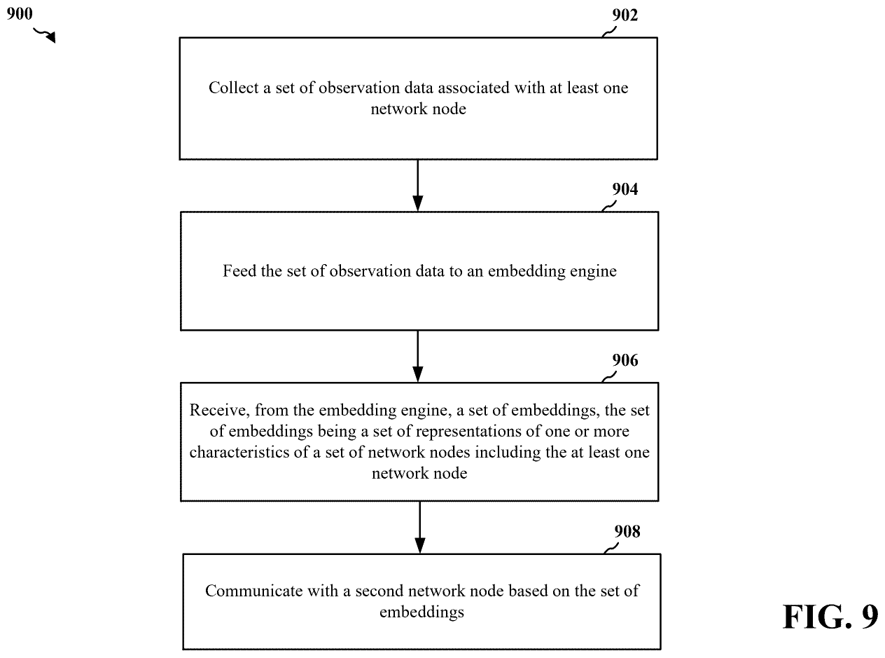

FIG. 9 is a flowchart 900 of a method of wireless communication. The method may be performed by a UE (e.g., the UE 104, the UE 802; the apparatus 1304). The method may enable a UE to more efficiently communicate with the network node by adapting its own behavior based on a representation of the network node. As one particular example, the UE may be performing grant prediction (e.g., predicting modulation and coding scheme (MCS) associated with a grant) based on the representation of the network node. Based on the grant prediction, the UE may adapt its RF transceiver.

At 902, the UE may collect a set of observation data associated with at least one network node. For example, the UE 802 may collect (e.g. at 806) a set of observation data associated with at least one network node. In some aspects, 902 may be performed by prediction component 198.

At 904, the UE may feed the set of observation data to an embedding engine. For example, the UE 802 may feed (e.g. at 808) the set of observation data to an embedding engine. In some aspects, 904 may be performed by prediction component 198.

At 906, the UE may receive, from the embedding engine, a set of embeddings, the set of embeddings being a set of representations of one or more characteristics of a set of network nodes including the at least one network node. For example, the UE 802 may receive, from the embedding engine, a set of embeddings (e.g., 810), the set of embeddings being a set of representations of one or more characteristics of a set of network nodes including the at least one network node. In some aspects, 906 may be performed by prediction component 198.

At 908, the UE may communicate with a second network node based on the set of embeddings. For example, the UE 802 may communicate (e.g., advertise different capability or adapt power management at the UE that may affect a RF transceiver at the UE based on the set of embeddings) with a second network node (e.g., 804) based on the set of embeddings (e.g., 810). In some aspects, 908 may be performed by prediction component 198.

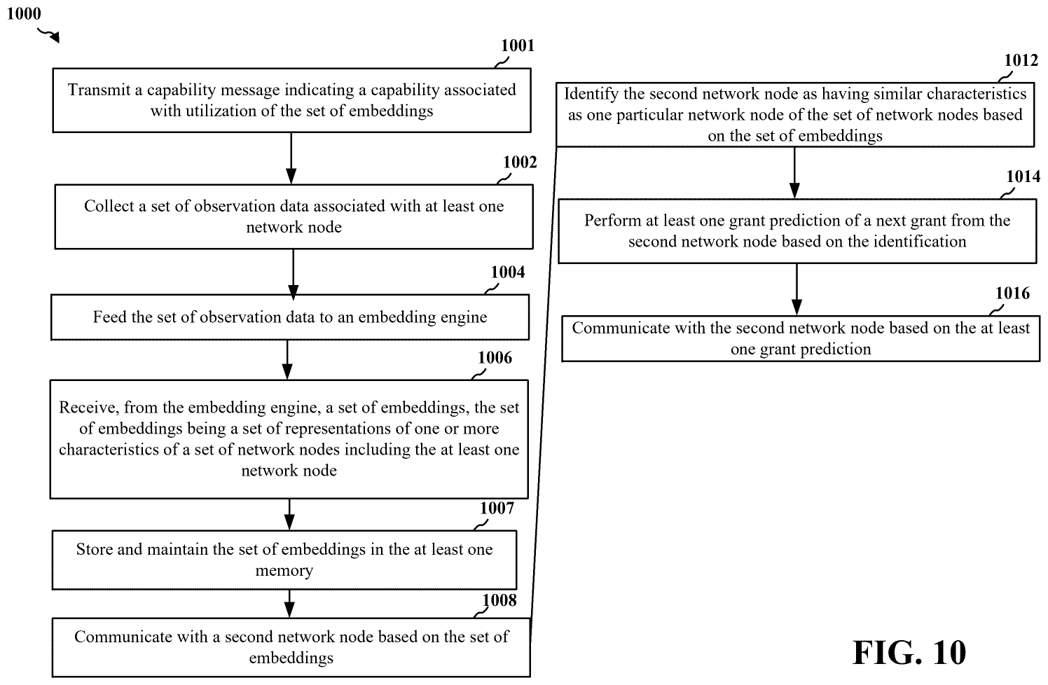

FIG. 10 is a flowchart 1000 of a method of wireless communication. The method may be performed by a UE (e.g., the UE 104, the UE 802; the apparatus 1304). The method may enable a UE to more efficiently communicate with the network node by adapting its own behavior based on a representation of the network node. As one particular example, the UE may be performing grant prediction (e.g., predicting modulation and coding scheme (MCS) associated with a grant) based on the representation of the network node. Based on the grant prediction, the UE may adapt its RF transceiver.

At 1001, the UE may transmit a capability message indicating a capability associated with utilization of the set of embeddings. For example, the UE 802 may transmit a capability message (e.g., 814) indicating a capability associated with utilization of the set of embeddings. In some aspects, 1001 may be performed by prediction component 198.

At 1002, the UE may collect a set of observation data associated with at least one network node. For example, the UE 802 may collect (e.g. at 806) a set of observation data associated with at least one network node. In some aspects, 1002 may be performed by prediction component 198. In some aspects, the set of observation data (e.g., 702) includes a set of link level protocol interaction data (e.g., in 702) between the UE and the at least one network node, where the set of link level protocol interaction data includes data associated with at least one of: a PHY layer signaling, a MAC level signaling, a HARQ result, a CSF report, a CQI, a rank indicator, a PDSCH grant rank, or a MCS.

At 1004, the UE may feed the set of observation data to an embedding engine. For example, the UE 802 may feed (e.g. at 808) the set of observation data to an embedding engine. In some aspects, 1004 may be performed by prediction component 198. In some aspects, the embedding engine is located at the UE (e.g., 602) or a server (e.g., 650) separate from the UE.

At 1006, the UE may receive, from the embedding engine, a set of embeddings, the set of embeddings being a set of representations of one or more characteristics of a set of network nodes including the at least one network node. For example, the UE 802 may receive, from the embedding engine, a set of embeddings (e.g., 810), the set of embeddings being a set of representations of one or more characteristics of a set of network nodes including the at least one network node (e.g., 804). In some aspects, 1006 may be performed by prediction component 198. In some aspects, the set of embeddings are categorized based on a set of respective manufacturers associated with the set of network nodes, and where the set of representations are associated with a set of schedulers associated with the set of network nodes. In some aspects, the set of embeddings are based on: (1) a set of linear projections (e.g., 704) of the set of observation data (e.g., 702), each linear projection of the set of linear projections corresponding to one respective slot (e.g., 0, 1, 2, . . . 40 in FIG. 7) associated with the set of observation data, (2) a set of transform encoder outputs (e.g., output by 708) based on the set of linear projections, one or more classify token (e.g., in 706) associated with the set of linear projections (e.g., 704) being categorized based on the set of respective manufacturers, and (3) at least one context (e.g., associated with 712A) and at least one rank (e.g., associated with 712B) associated with the set of transform encoder outputs (e.g., output by 708). In some aspects, the set of representations in the set of embeddings is based on a location associated with the UE.

At 1007, the UE may store and maintain the set of embeddings in the at least one memory. For example, the UE 802 may store and maintain (e.g., at 812) the set of embeddings in the at least one memory. In some aspects, 1007 may be performed by prediction component 198.

At 1008, the UE may communicate with a second network node based on the set of embeddings. For example, the UE 802 may communicate with a second network node (e.g., 804) based on the set of embeddings (e.g., 810). In some aspects, 1008 may be performed by prediction component 198.

At 1012, the UE may identify the second network node as having similar characteristics as one particular network node of the set of network nodes based on the set of embeddings. For example, the UE 802 may identify (e.g., at 817) the second network node as having similar characteristics as one particular network node of the set of network nodes based on the set of embeddings. In some aspects, 1012 may be performed by prediction component 198.

At 1014, the UE may perform at least one grant prediction of a next grant from the second network node based on the identification. For example, the UE 802 may perform (e.g., at 817) at least one grant prediction of a next grant from the second network node based on the identification. In some aspects, 1014 may be performed by prediction component 198.

At 1016, the UE may communicate with the second network node based on the at least one grant prediction. For example, the UE 802 may communicate (e.g., receive grant 818) with the second network node based on the at least one grant prediction. In some aspects, 1016 may be performed by prediction component 198. In some aspects, the UE may perform each of the at least one grant prediction in parallel using a respective embedding of the set of embeddings and select a best performing grant prediction of the at least one grant prediction.

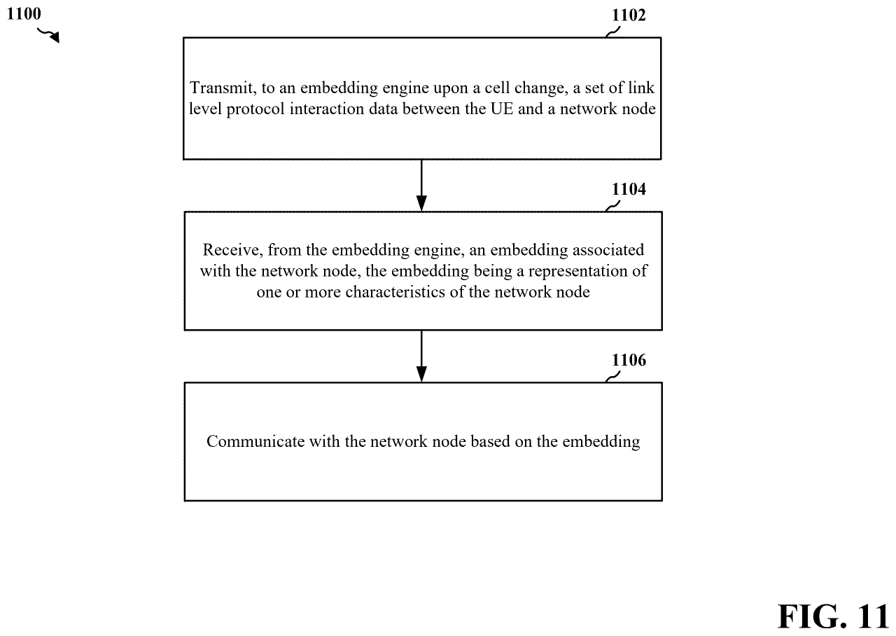

FIG. 11 is a flowchart 1100 of a method of wireless communication. The method may be performed by a UE (e.g., the UE 104, the UE 802; the apparatus 1304). The method may enable a UE to more efficiently communicate with the network node by adapting its own behavior based on a representation of the network node. As one particular example, the UE may be performing grant prediction (e.g., predicting modulation and coding scheme (MCS) associated with a grant) based on the representation of the network node. Based on the grant prediction, the UE may adapt its RF transceiver.

At 1102, the UE may transmit, to an embedding engine upon a cell change, a set of link level protocol interaction data between the UE and a network node. For example, the UE 802 may transmit (e.g., at 852), to an embedding engine upon a cell change, a set of link level protocol interaction data between the UE and a network node 804. In some aspects, 1102 may be performed by prediction component 198.

At 1104, the UE may receive, from the embedding engine, an embedding associated with the network node, the embedding being a representation of one or more characteristics of the network node. For example, the UE 802 may receive, from the embedding engine, an embedding (e.g., 854) associated with the network node, the embedding being a representation of one or more characteristics of the network node. In some aspects, 1104 may be performed by prediction component 198.

At 1106, the UE may communicate with the network node based on the embedding. For example, the UE 802 may communicate (e.g., at 856) with the network node 804 based on the embedding (e.g., 854). In some aspects, 1106 may be performed by prediction component 198.

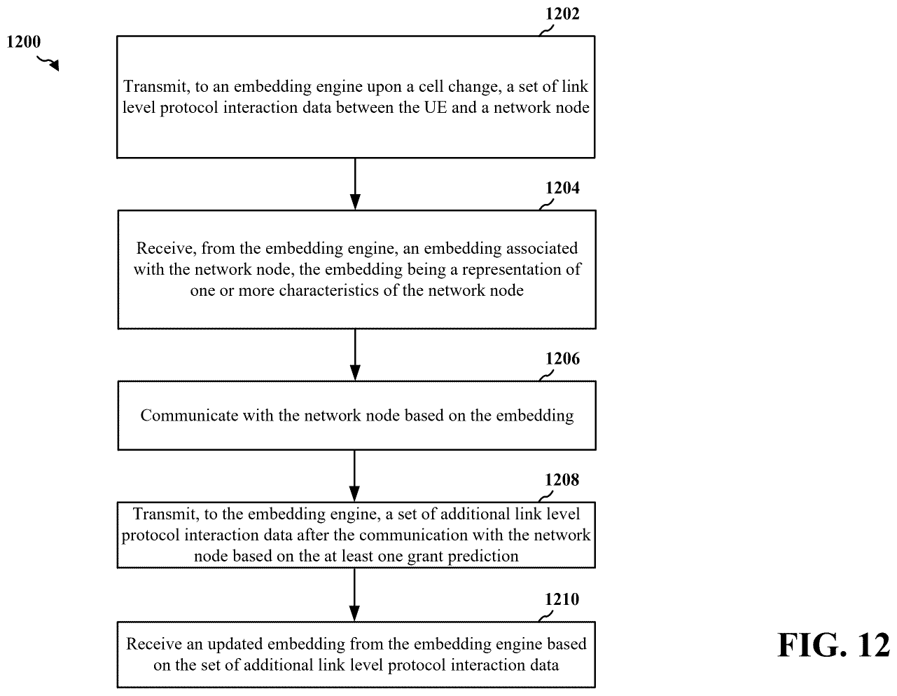

FIG. 12 is a flowchart 1200 of a method of wireless communication. The method may be performed by a UE (e.g., the UE 104, the UE 802; the apparatus 1304). The method may enable a UE to more efficiently communicate with the network node by adapting its own behavior based on a representation of the network node. As one particular example, the UE may be performing grant prediction (e.g., predicting modulation and coding scheme (MCS) associated with a grant) based on the representation of the network node. Based on the grant prediction, the UE may adapt its RF transceiver.

At 1202, the UE may transmit, to an embedding engine upon a cell change, a set of link level protocol interaction data between the UE and a network node. For example, the UE 802 may transmit (e.g., at 852), to an embedding engine upon a cell change, a set of link level protocol interaction data (e.g., in 702) between the UE and a network node 804. In some aspects, 1202 may be performed by prediction component 198. In some aspects, the set of link level protocol interaction data includes data associated with at least one of: a PHY layer signaling, a MAC level signaling, a HARQ result, a CSF report, a CQI, a rank indicator, a PDSCH grant rank, or a MCS.

At 1204, the UE may receive, from the embedding engine, an embedding associated with the network node, the embedding being a representation of one or more characteristics of the network node. For example, the UE 802 may receive, from the embedding engine, an embedding (e.g., 854) associated with the network node, the embedding being a representation of one or more characteristics of the network node. In some aspects, 1204 may be performed by prediction component 198. In some aspects, the embedding is associated with a scheduler associated with the network node. In some aspects, the embedding is based on: (1) a set of linear projections (e.g., 704) of a set of observation data (e.g., 702), each linear projection of the set of linear projections corresponding to one respective slot (e.g., 0, 1, 2, . . . 40 in FIG. 7) associated with the set of observation data (e.g., 702), (2) a set of transform encoder outputs (e.g., output by 708) based on the set of linear projections, one or more classify token (e.g., in 706) associated with the set of linear projections being categorized based on a set of manufacturers, and (3) at least one context (e.g., associated with 712A) and at least one rank (e.g., associated with 712B) associated with the set of transform encoder outputs.

At 1206, the UE may communicate with the network node based on the embedding. For example, the UE 802 may communicate (e.g., at 856) with the network node 804 based on the embedding (e.g., 854). In some aspects, 1206 may be performed by prediction component 198. In some aspects, the UE may perform at least one grant prediction of a next grant from the network node based on the embedding and communicate with the network node based on the at least one grant prediction.

At 1208, the UE may transmit, to the embedding engine, a set of additional link level protocol interaction data after the communication with the network node based on the at least one grant prediction. In some aspects, 1208 may be performed by prediction component 198. At 1210, the UE may receive an updated embedding from the embedding engine based on the set of additional link level protocol interaction data. In some aspects, 1210 may be performed by prediction component 198.

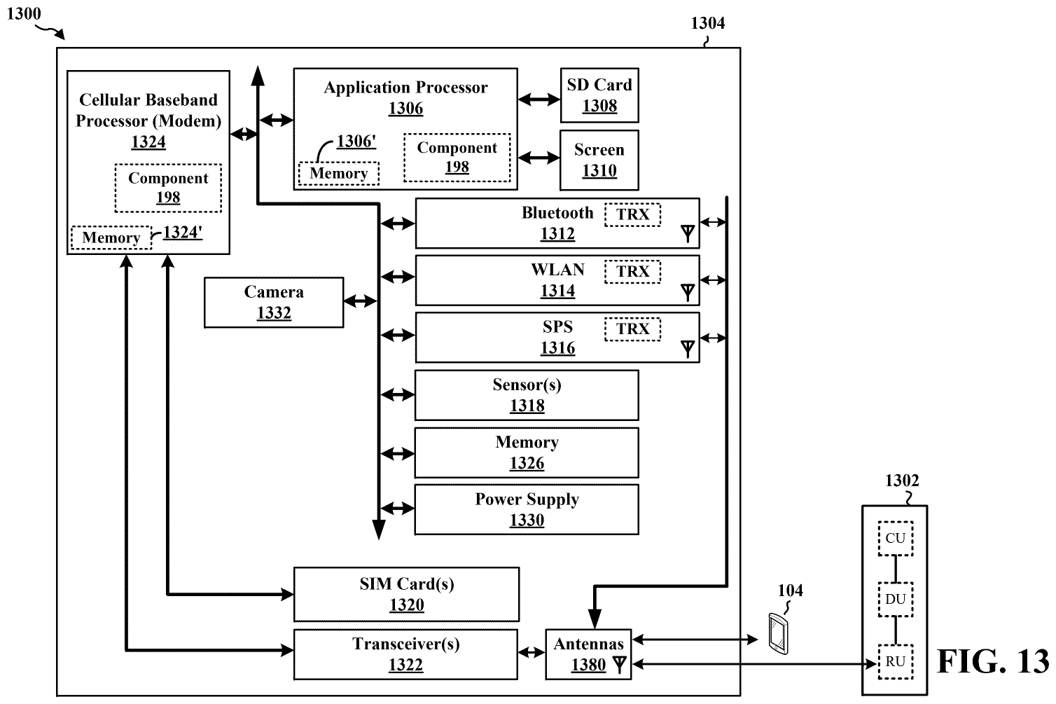

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) 1324 communicates through the transceiver(s) 1322 via one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, the prediction component 198 may be configured to collect a set of observation data associated with at least one network node. In some aspects, the prediction component 198 may be configured to feed the set of observation data to an embedding engine. In some aspects, the prediction component 198 may be configured to receive, from the embedding engine, a set of embeddings, the set of embeddings being a set of representations of one or more characteristics of a set of network nodes including the at least one network node. In some aspects, the prediction component 198 may be configured to communicate with a second network node based on the set of embeddings. In some aspects, the prediction component 198 may be configured to transmit, to an embedding engine upon a cell change, a set of link level protocol interaction data between the UE and a network node. In some aspects, the prediction component 198 may be configured to receive, from the embedding engine, an embedding associated with the network node, the embedding being a representation of one or more characteristics of the network node.

In some aspects, the prediction component 198 may be configured to communicate with the network node based on the embedding. The prediction component 198 may be within the cellular baseband processor(s) 1324, the application processor(s) 1306, or both the cellular baseband processor(s) 1324 and the application processor(s) 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, may include means for collecting a set of observation data associated with at least one network node. In some aspects, the apparatus 1304 may include means for feeding the set of observation data to an embedding engine. In some aspects, the apparatus 1304 may include means for receiving, from the embedding engine, a set of embeddings, the set of embeddings being a set of representations of one or more characteristics of a set of network nodes including the at least one network node. In some aspects, the apparatus 1304 may include means for communicating with a second network node based on the set of embeddings. In some aspects, the apparatus 1304 may include means for identifying the second network node as having similar characteristics as one particular network node of the set of network nodes based on the set of embeddings. In some aspects, the apparatus 1304 may include means for performing at least one grant prediction of a next grant from the second network node based on the identification. In some aspects, the apparatus 1304 may include means for communicating with the second network node based on the at least one grant prediction. In some aspects, the apparatus 1304 may include means for performing each of the at least one grant prediction in parallel using a respective embedding of the set of embeddings. In some aspects, the apparatus 1304 may include means for selecting a best performing grant prediction of the at least one grant prediction. In some aspects, the apparatus 1304 may include means for transmitting a capability message indicating a capability associated with utilization of the set of embeddings. In some aspects, the apparatus 1304 may include means for storing and maintaining the set of embeddings in the at least one memory. In some aspects, the apparatus 1304 may include means for transmitting, to an embedding engine upon a cell change, a set of link level protocol interaction data between the UE and a network node. In some aspects, the apparatus 1304 may include means for receiving, from the embedding engine, an embedding associated with the network node, the embedding being a representation of one or more characteristics of the network node. In some aspects, the apparatus 1304 may include means for communicating with the network node based on the embedding. In some aspects, the apparatus 1304 may include means for performing at least one grant prediction of a next grant from the network node based on the embedding. In some aspects, the apparatus 1304 may include means for communicating with the network node based on the at least one grant prediction. In some aspects, the apparatus 1304 may include means for transmitting, to the embedding engine, a set of additional link level protocol interaction data after the communication with the network node based on the at least one grant prediction. In some aspects, the apparatus 1304 may include means for receiving an updated embedding from the embedding engine based on the set of additional link level protocol interaction data. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method for wireless communication performed by a user equipment (UE): collecting a set of observation data associated with at least one network node; feeding the set of observation data to an embedding engine; receiving, from the embedding engine, a set of embeddings, the set of embeddings being a set of representations of one or more characteristics of a set of network nodes including the at least one network node; and communicating with a second network node based on the set of embeddings.

Aspect 2 is the method of aspect 1, where the set of observation data comprises a set of link level protocol interaction data between the UE and the at least one network node, where the set of link level protocol interaction data comprises data associated with at least one of: a physical (PHY) layer signaling, a medium access control (MAC) level signaling, a hybrid automatic repeat request (HARQ) result, a channel state feedback (CSF) report, a channel quality indicator (CQI), a rank indicator, a physical downlink shared channel (PDSCH) grant rank, or a modulation and coding scheme (MCS).

Aspect 3 is the method of any of aspects 1-2, where the set of embeddings are categorized based on a set of respective manufacturers associated with the set of network nodes, and where the set of representations are associated with a set of schedulers associated with the set of network nodes.

Aspect 4 is the method of aspect 3, where the set of embeddings are based on: (1) a set of linear projections of the set of observation data, each linear projection of the set of linear projections corresponding to one respective slot associated with the set of observation data, (2) a set of transform encoder outputs based on the set of linear projections, one or more classify token associated with the set of linear projections being categorized based on the set of respective manufacturers, and (3) at least one context and at least one rank associated with the set of transform encoder outputs.

Aspect 5 is the method of any of aspects 1-4, where the embedding engine is located at the UE or a server separate from the UE.

Aspect 6 is the method of aspect 1, where communicating with the second network node further includes: identifying the second network node as having similar characteristics as one particular network node of the set of network nodes based on the set of embeddings; performing at least one grant prediction of a next grant from the second network node based on an identification of the second network node; and communicating with the second network node based on the at least one grant prediction.

Aspect 7 is the method of aspect 6, where performing the at least one grant prediction based on the identification includes: performing each of the at least one grant prediction in parallel using a respective embedding of the set of embeddings; and selecting a best performing grant prediction of the at least one grant prediction.

Aspect 8 is the method of any of aspects 1-7, further including: transmitting a capability message indicating a capability associated with utilization of the set of embeddings.

Aspect 9 is the method of any of aspects 1-8, further including: storing and maintaining the set of embeddings in at least one memory.

Aspect 10 is the method of any of aspects 1-9, where the set of representations in the set of embeddings is based on a location associated with the UE.

Aspect 11 is a method for wireless communication performed by a user equipment (UE), including: transmitting, to an embedding engine upon a cell change, a set of link level protocol interaction data between the UE and a network node; receiving, from the embedding engine, an embedding associated with the network node, the embedding being a representation of one or more characteristics of the network node; and communicating with the network node based on the embedding.

Aspect 12 is the method of aspect 11, where the set of link level protocol interaction data comprises data associated with at least one of: a physical (PHY) layer signaling, a medium access control (MAC) level signaling, a hybrid automatic repeat request (HARQ) result, a channel state feedback (CSF) report, a channel quality indicator (CQI), a rank indicator, a physical downlink shared channel (PDSCH) grant rank, or a modulation and coding scheme (MCS).

Aspect 13 is the method of any of aspects 11-12, where the embedding is associated with a scheduler associated with the network node.

Aspect 14 is the method of aspect 13, where the embedding is based on: (1) a set of linear projections of a set of observation data, each linear projection of the set of linear projections corresponding to one respective slot associated with the set of observation data, (2) a set of transform encoder outputs based on the set of linear projections, one or more classify token associated with the set of linear projections being categorized based on a set of manufacturers, and (3) at least one context and at least one rank associated with the set of transform encoder outputs.

Aspect 15 is the method of any of aspects 11-14, where communicating with the network node further includes: performing at least one grant prediction of a next grant from the network node based on the embedding; and communicating with the network node based on the at least one grant prediction.

Aspect 16 is the method of aspect 15, further including: transmitting, to the embedding engine, a set of additional link level protocol interaction data after the communication with the network node based on the at least one grant prediction; and receiving an updated embedding from the embedding engine based on the set of additional link level protocol interaction data.

Aspect 17 is an apparatus for wireless communication at a device including at least one memory and at least one processor coupled to the at least one memory and, the at least one processor, individually or in any combination, based at least in part on information stored in the at least one memory, the at least one processor is configured to implement any of aspects 1 to 16.

Aspect 18 is the apparatus of aspect 17, further including one or more transceivers or one or more antennas coupled to the at least one processor.

Aspect 19 is an apparatus for wireless communication at a device including means for implementing any of aspects 1 to 16.

Aspect 20 is a computer-readable medium (e.g., a non-transitory computer-readable medium) storing computer executable code, where the code when executed by at least one processor causes the at least one processor to implement any of aspects 1 to 16.

What is claimed is:

1. An apparatus for wireless communication at a user equipment (UE), comprising:
at least one memory; and
at least one processor coupled to the at least one memory, and based at least in part on information stored in the at least one memory, the at least one processor, individually or in any combination, is configured to cause the UE to:
collect a set of observation data associated with at least one network node;
feed the set of observation data to an embedding engine;
receive, from the embedding engine, a set of embeddings, the set of embeddings being a set of representations of one or more characteristics of a set of network nodes including the at least one network node; and
communicate with a second network node based on the set of embeddings.

2. The apparatus of claim 1, wherein the set of observation data comprises a set of link level protocol interaction data between the UE and the at least one network node, wherein the set of link level protocol interaction data comprises data associated with at least one of: a physical (PHY) layer signaling, a medium access control (MAC) level signaling, a hybrid automatic repeat request (HARQ) result, a channel state feedback (CSF) report, a channel quality indicator (CQI), a rank indicator, a physical downlink shared channel (PDSCH) grant rank, or a modulation and coding scheme (MCS).

3. The apparatus of claim 1, wherein the set of embeddings are categorized based on a set of respective manufacturers associated with the set of network nodes, and wherein the set of representations are associated with a set of schedulers associated with the set of network nodes.

4. The apparatus of claim 3, wherein the set of embeddings are based on: (1) a set of linear projections of the set of observation data, each linear projection of the set of linear projections corresponding to one respective slot associated with the set of observation data, (2) a set of transform encoder outputs based on the set of linear projections, one or more classify token associated with the set of linear projections being categorized based on the set of respective manufacturers, and (3) at least one context and at least one rank associated with the set of transform encoder outputs.

5. The apparatus of claim 1, wherein the embedding engine is located at the UE or a server separate from the UE.

6. The apparatus of claim 1, wherein to communicate with the second network node, the at least one processor, individually or in any combination, is configured to cause the UE to:
identify the second network node as having similar characteristics as one particular network node of the set of network nodes based on the set of embeddings;
perform at least one grant prediction of a next grant from the second network node based on an identification of the second network node; and
communicate with the second network node based on the at least one grant prediction.

7. The apparatus of claim 6, wherein to perform the at least one grant prediction based on the identification, the at least one processor, individually or in any combination, is configured to cause the UE to:
perform each of the at least one grant prediction in parallel using a respective embedding of the set of embeddings; and
select a best performing grant prediction of the at least one grant prediction.

8. The apparatus of claim 1, wherein the at least one processor, individually or in any combination, is further configured to cause the UE to:
transmit a capability message indicating a capability associated with utilization of the set of embeddings.

9. The apparatus of claim 1, wherein the at least one processor, individually or in any combination, is further configured to cause the UE to:
store and maintain the set of embeddings in the at least one memory.

10. The apparatus of claim 1, wherein the set of representations in the set of embeddings is based on a location associated with the UE.

11. An apparatus for wireless communication at a user equipment (UE), comprising:
at least one memory; and
at least one processor coupled to the at least one memory, and based at least in part on information stored in the at least one memory, the at least one processor, individually or in any combination, is configured to cause the UE to:
transmit, to an embedding engine upon a cell change, a set of link level protocol interaction data between the UE and a network node;
receive, from the embedding engine, an embedding associated with the network node, the embedding being a representation of one or more characteristics of the network node; and
communicate with the network node based on the embedding.

12. The apparatus of claim 11, wherein the set of link level protocol interaction data comprises data associated with at least one of: a physical (PHY) layer signaling, a medium access control (MAC) level signaling, a hybrid automatic repeat request (HARQ) result, a channel state feedback (CSF) report, a channel quality indicator (CQI), a rank indicator, a physical downlink shared channel (PDSCH) grant rank, or a modulation and coding scheme (MCS).

13. The apparatus of claim 11, wherein the embedding is associated with a scheduler associated with the network node.

14. The apparatus of claim 13, wherein the embedding is based on: (1) a set of linear projections of a set of observation data, each linear projection of the set of linear projections corresponding to one respective slot associated with the set of observation data, (2) a set of transform encoder outputs based on the set of linear projections, one or more classify token associated with the set of linear projections being categorized based on a set of manufacturers, and (3) at least one context and at least one rank associated with the set of transform encoder outputs.

15. The apparatus of claim 11, wherein to communicate with the network node, the at least one processor, individually or in any combination, is configured to cause the UE to:
perform at least one grant prediction of a next grant from the network node based on the embedding; and
communicate with the network node based on the at least one grant prediction.

16. The apparatus of claim 15, wherein the at least one processor, individually or in any combination, is further configured to cause the UE to:
transmit, to the embedding engine, a set of additional link level protocol interaction data after communication with the network node based on the at least one grant prediction; and
receive an updated embedding from the embedding engine based on the set of additional link level protocol interaction data.

17. A method for wireless communication performed by a user equipment (UE), comprising:
collecting a set of observation data associated with at least one network node;
feeding the set of observation data to an embedding engine;
receiving, from the embedding engine, a set of embeddings, the set of embeddings being a set of representations of one or more characteristics of a set of network nodes including the at least one network node; and
communicating with a second network node based on the set of embeddings.

18. The method of claim 17, wherein the set of observation data comprises a set of link level protocol interaction data between the UE and the at least one network node, wherein the set of link level protocol interaction data comprises data associated with at least one of: a physical (PHY) layer signaling, a medium access control (MAC) level signaling, a hybrid automatic repeat request (HARQ) result, a channel state feedback (CSF) report, a channel quality indicator (CQI), a rank indicator, a physical downlink shared channel (PDSCH) grant rank, or a modulation and coding scheme (MCS).

19. The method of claim 17, wherein the set of embeddings are categorized based on a set of respective manufacturers associated with the set of network nodes, and wherein the set of representations are associated with a set of schedulers associated with the set of network nodes.

20. The method of claim 19, wherein the set of embeddings are based on: (1) a set of linear projections of the set of observation data, each linear projection of the set of linear projections corresponding to one respective slot associated with the set of observation data, (2) a set of transform encoder outputs based on the set of linear projections, one or more classify token associated with the set of linear projections being categorized based on the set of respective manufacturers, and (3) at least one context and at least one rank associated with the set of transform encoder outputs.
